(19) United States
(12) Patent Application Publication
(10) Pub. No.: US 2026/0268513 A1
(43) Pub. Date: Sep. 10, 2026

(54) Systems and Methods for Fast Object Detection in Compressed Domains

(71) Applicant: PERCIPIENT.AI INC., Santa Clara, CA (US)

(72) Inventors: Ryan TRAN, Rancho Santa Margarita, CA (US); Atul KANAUJIA, San Jose, CA (US); Vasudev PARAMESWARAN, Fremont, CA (US)

(73) Assignee: PERCIPIENT.AI INC., Santa Clara, CA (US)

(21) Appl. No.: 19/163,347

(22) PCT Filed: Mar. 7, 2024
(86) PCT No.: PCT/US2024/018972

§ 371 Date: Sep. 8, 2025

Related U.S. Application Data
(60) Provisional application No. 63/450,956, filed on Mar. 8, 2023.

(51) Int. Cl. G06T 7/70; G06N 3/045; G06N 3/09; G06V 10/25; G06V 10/82

(52) U.S. Cl. CPC G06T 7/70; G06N 3/045; G06N 3/09; G06V 10/25; G06V 10/82; G06V 2201/07

(57) ABSTRACT

Methods and systems for performing detections at native resolution in high resolution video streams without requiring reconstruction of each frame comprises a baseline detector for performing object detections on key frames such as I frames in H.264 or H.265 video together with a shift lightweight neural network for calculating, from accumulated motion vectors of intermediate frames such as B frames and P frames, shift in the object detections and also together with a refine lightweight neural network responsive to the calculations from the shift network and accumulated frame residuals of the intermediate frames to determine object detections in the intermediate frames.

### RELATED APPLICATIONS

This application claims the benefit of U.S. Patent Application Ser. 63/450,956 filed Mar. 8, 2023. Further, the following U.S. patent applications are incorporated herein by reference: Ser. No. 17/938,042 filed Oct. 4, 2022; Ser. No. 17/866,396 filed Jul. 15, 2022; Ser. No. 17/866,389 filed Jul. 15, 2022; and Ser. No. 16/120,128 filed Aug. 31, 2018.

### FIELD OF THE INVENTION

This invention relates generally to object detection for use in machine learned models and more particularly relates to methods and systems for processing compressed video to improve object detection speed and accuracy on native resolution video streams.

### BACKGROUND OF THE INVENTION

Despite the rapid evolution of video resolutions and progress on object detection in still imagery, object detection in video has had three main challenges so far. Firstly, models typically target a universally accepted default resolution of 512×512. In theory, fully convolutional CNN architectures in most existing deep learning models allow any input resolution to be processed. However, in practice, inferencing on non-native input resolutions results in subpar accuracy while inferencing on native (almost always higher) resolutions incurs significant computational costs, making it impractical for real-time applications. Secondly, relatively little work has gone into object detection directly on compressed data. Thirdly, while a lot of publicly available training data exists for object detection in still images, a relatively negligible amount exists for video, stymying research on approaches for object detection in video.

Most existing live camera processing and alerting frameworks process data at low resolutions (typically 512×512) even though fully convolutional networks allow inputs to be processed at any resolution. Object detectors trained for variable input resolutions (e.g. up to 1024×1024) have the ability to extrapolate and process inputs at much high resolutions. However, their use as is requires higher computational cost, continuous decoding of images, and significantly high throughput. Similarly, brute force approaches to split video streams into parallel low-resolution streams do not work if the scale of the object exhibits wide variation. Classical pyramidal processing also incurs significant processing cost due to the additional processing needed.

Despite the rapid evolution of video resolutions and progress on object detection in still imagery, object detection in video has had three main challenges so far. Firstly, as noted above, models typically target a universally accepted default resolution of 512×512. In theory, fully convolutional CNN architectures in most existing deep learning models allow any input resolution to be processed. However, in practice, inferencing on non-native input resolutions results in subpar accuracy while inferencing on native (almost always higher) resolutions incurs significant computational costs, making it impractical for real-time applications. Secondly, relatively little work has gone into object detection directly on compressed data, thus ignoring aspects of the data that might offer great speed and, in some instances, improved accuracy. Thirdly, while a lot of publicly available training data exists for object detection in still images, a relatively negligible amount exists for video, stymying research on approaches for object detection in video.

One approach has been to process high resolution videos sparsely, and apply fast tracking algorithms to propagate detections in the intermediate frames. Researchers have attempted to incorporate temporal context as a signal for tracking. However, sequence modeling approaches, for example recursive nets and LSTMs, have not found wide acceptance in vision, mainly due to their high computational costs and limited applicability for processing high resolution videos. While a majority of approaches have required decoded frames, some have attempted to run inference in compressed domain without great success.

Algorithms seeking to speed up computer vision tasks in video typically propagate information such as image features, object proposals, and optical flow. The task of action recognition in a compressed domain has been addressed by a number of researchers. One of the early efforts incorporated accumulated motion vectors and residuals as a loosely coupled framework for fast inference on videos, and used independently trained separate models for 1-frames, motion-vector frames and residual frames. The action recognition scores from individual models were aggregated by simply summing individual model scores. DMC-net is a lightweight generator network to reconstruct flow-like signals from low resolution, imprecise motion vector signals in compressed videos. That effort demonstrated significant speed gains at the same level of accuracy, compared to frameworks that used optical flow. Two-stream convolution networks have found success in action recognition but are inherently slow due to optical flow computation. Other efforts improved the speed by twenty-seven times by replacing optical flows with the motion vectors from the compressed videos, but which tend to be much coarser and noisy. Some research into context and motion decoupling advocates use of motion vector cues in the videos for embedding high-level motion representations in their learning framework using self-supervision. Still, none of these approaches provides an efficient solution for processing compressed streams of high resolution video.

Between the dearth of efficient processing techniques for high resolution video, and the explosion of high resolution video, including compressed video, available for analysis, there has been a long-felt need for processes, systems and techniques that enables object detection on native resolution video streams with increased speed and accuracy.

### SUMMARY OF THE INVENTION

The present invention substantially overcomes aspects of all three of the afore-mentioned challenges through the use of a self-supervised approach for incorporating motion cues from compressed video to improve object detection speed and accuracy on native resolution video streams. It is well recognized that detection performance improves with increased resolution, but it is equally well recognized that processing native resolution video streams using prior art techniques requires computational costs that have generally been deemed unacceptable. In contrast to that limitation of the prior art, the present invention can process detections at native resolution on high resolution video streams that have been compressed by a protocol that uses sparse key frames and motion vectors for the intermediate frames. For example, H.264 and H.265 compression protocols comprise temporally sparse I-frames together with intermediate P-frames and B-frames, and are well suited for processing by the present invention at native resolution.

In an embodiment, the methods, systems and techniques described hereinafter show a speed gain of 5× in inferencing when compared to a frame-by-frame detector, while also providing better detection accuracy for static cameras and only a marginal loss of accuracy for moving cameras. In at least some embodiments, the invention exploits rich temporal cues in the compressed video streams to not only reduce the computational cost at inference time, but also, in some cases, to increase accuracy

In an embodiment, an aspect of the invention takes advantage of the fact that video compression algorithms are fairly mature and optimized for storing visual data in highly optimized formats. As a result, decoding the entire video frame and processing each frame individually is redundant and wasteful of computing resources, especially if the changes are limited to a small localized regions in the scene as is frequently the case in object detection where the object is being detected through a segment of multiple frames.

An embodiment of the invention comprises a framework for exploiting a generic frame level object detector by confining its use to spatially localized regions of interest in the scene captured in a key frame. A key frame will sometimes also be referred to herein as an I-frame. Two small customized networks, both preferably lightweight neural networks, are trained on the output distribution of the generic detector during the training phase, and then handle a lightweight propagation of the detections to the intermediate frames. Training happens seamlessly on unlabeled representative data in a fully unsupervised fashion, using teacher-student knowledge transfer, which obviates the need for the two lightweight networks to train on any additional labeled data. This facilitates processing very high resolution videos at native resolution without the need to decode the entire frame, while maintaining a comparable level of accuracy.

In an embodiment, a traditional object detector (referred to as the Baseline detector in some instances herein) is provided that detects one or more object classes operating on an image. The detector may be optimized for high resolution frames such as HD or 4K-UHD. The framework speeds up video processing by extracting detections from a sparse set of frames, i.e., the key frames or I-frames, using the computationally expensive Baseline detector and then propagating localized changes for these detections to obtain refined detections on a significantly large number of intermediate frames. To that end, the system uses pre-encoded information in the video for the propagation. Propagation is achieved by two lightweight neural networks referred to herein as the Shift network and the Refine or Refinement network. As discussed hereinafter, these lightweight neural networks are structured to be much faster than the baseline network, and to not require the entire image to be decoded. The combination of using the larger and slower baseline detector only on I-frames, and then using two faster lightweight neural networks, Shift and Refine, to manage propagation of the detections to the intermediate P-frames and B-frames, significantly reduces the computational burden of processing high resolution images at native resolution, thus increasing throughput without sacrificing accuracy.

In an embodiment, the Refinement network is used to overcome the lack of rich motion information in the compressed video while the Shift network ensures that the decoding of a frame patch is needed only in a localized region, thus amplifying speed gains. The video decoding process is therefore tightly coupled with the Baseline detector, requiring only sparse and localized reconstructions in the majority of frames.

It is therefore one object of the present invention to provide a method for improving object detection speed and accuracy on native resolution video streams.

It is a further object of the present invention to utilize rich temporal cues in the compressed video to improve inference speed.

It is a still further object of the present invention to utilize such rich temporal cues to improve accuracy in at least some contexts.

A still further object of the invention is to speed up video processing by using a computationally expensive detector only for a sparse set of frames and then using fast specialized neural networks to compensate for the lack of rich motion information in the compressed video while at the same time ensuring that the decoding of a frame patch is needed only in a localized region.

These and other objects of the inventions will be better appreciated from the following Detailed Description of the Invention, taken in conjunction with the appended Figures.

### THE FIGURES

FIG. 1A illustrates in generalized form the elements of the method of an embodiment of the invention.

FIG. 1B illustrates in flow diagram form the process flow of an embodiment of the present invention including the processing of native resolution I frames in a baseline detector while either P frames or B frames, or both, are processed in lightweight neural networks.

FIG. 2 shows a comparison of motion vectors with flow for a pair of frames in accordance with an embodiment of the invention.

FIG. 3 shows, for an embodiment, how motion vector accumulation happens by passing an empty buffer for each macroblock from I-frame across consecutive P-frames, and adding motion vectors for every pair of source and destination frame.

FIG. 4 shows an embodiment of the use of “center prior” to train models that favor refined boxes located close to the center of the input patch, and is an example of ambiguity due to presence of multiple target objects (faces) in the input patch. Among the three possible targets, the prior favors target two as ΔC2<ΔC1<ΔC3.

FIG. 5 is an overview of a multiprocess inference pipeline in accordance with an embodiment of the invention.

FIGS. 6-9 are tables showing the performance gains achieved by an embodiment of the invention.

FIG. 10 is a plot showing, for an embodiment of the invention, changes in the accuracy with larger unlabeled datasets.

FIG. 11 shows a system configuration suitable for executing the processes and methods described herein, where the processor can be either a GPU or a CPU, although GPU's tend to be more efficient.

### DETAILED DESCRIPTION OF THE INVENTION

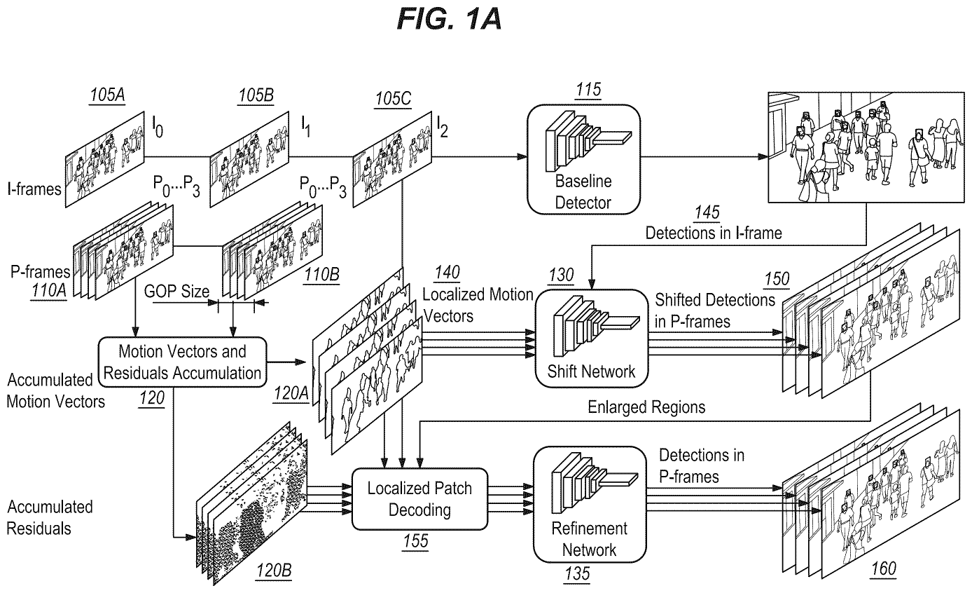

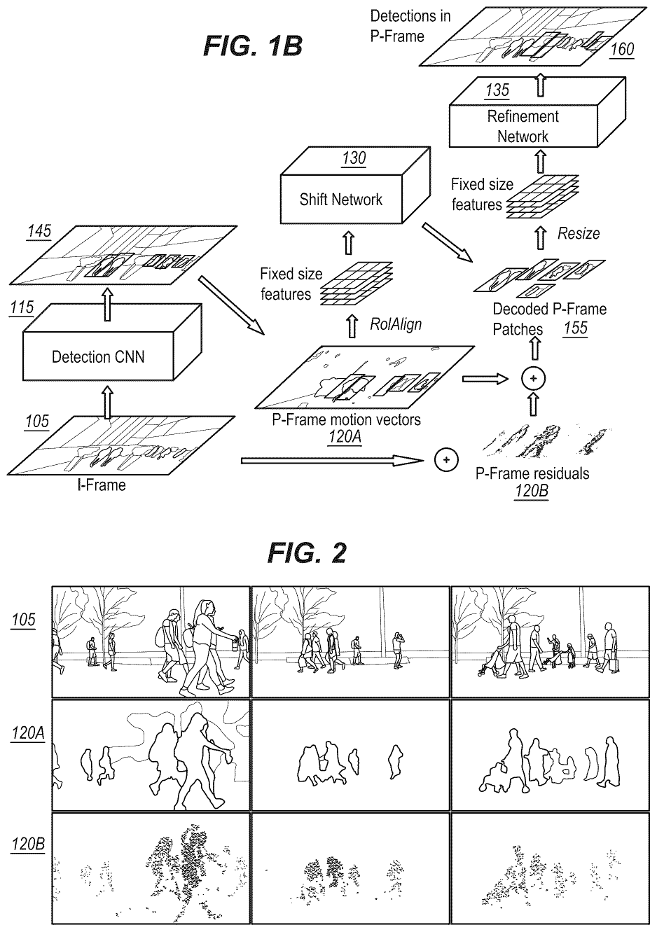

Referring first to FIGS. 1A-1B, these figures show an overview of an embodiment of the system of the present invention including the process flow executed by a processor-based system having associated memory, data storage and I/O devices. Among the numerous benefits of the invention, the framework of the present invention demonstrates:
That tight coupling of video decoding and model inference can yield significant performance gains.
The viability of spatially localized processing of high resolution videos at native resolution without significant loss of accuracy.
The viability of unsupervised learning of the lightweight Shift and Refine networks via teacher-student learning from the baseline detector
The viability of processing detections in high resolution video streams at native resolution without needing to run the baseline detector in every frame.

However, in some embodiments some features of invention may have limited applicability in certain scenarios, for example, fast moving objects appearing in the scene for less ⅓ s in a 30 fps video may not be detected in some embodiments, and the use of a fast-moving camera may fail to generate meaningful motion vectors.

For the task of object detection in an embodiment of the present invention, information from previous frames can be incorporated as either (1) multi-level feature maps from different stages of the deep network inference pipeline or (2) detections (of which, tracking is an example). The assumption behind feature propagation is that high-level feature maps encode spatial and contextual information about the object from the previous frames, and that encoded information does not vary significantly across consecutive frames. Prior efforts by others have involved designing a light-weight memory network (LSTM) to propagate features across multiple scales where attention is used to extract relevant regions in the feature map for propagation. Other prior efforts involve training a network to propagate features from motion vectors and residuals in the P-frames, where features are propagated across P-frames (short term) and then optical flow is used across I-frames (long term). DeltaCNN is a framework for processing changes in the inputs sparsely that extends deep network operations to support incremental changes (delta) as input to produce changes in the output. Linear operations can handle such deltas while non-linear operations need dense-accumulated inputs to generate deltas in the output. DeltaCNN is limited in that it can only work with static cameras and not moving cameras.

In contrast, the techniques used in the present invention, though not tracking per se, fall in the category of propagating detections. It was determined that incorporating frame differences in the feature maps is extremely difficult for object detection problems, which require precise localization of bounding boxes. While there exist prior art methods that incorporate flow to track object bounding boxes, only a few attempt to replace flows by motion vectors in a compressed domain. One of the earliest methods attempted to use motion vectors embedded in MPEG compressed videos to track a moving object and developed an algorithm to continue tracking that object even when the object has stopped moving. Prior art motion vector interpolation- and prediction-based methods essentially employ simplistic approaches to use noisy motion cues from the video compression and are not robust enough for objects moving in a crowd or with complex patterns. These frameworks do not support moving cameras and cannot handle changes in the size of the target due to camera motion and thus cannot solve the challenges noted above.

Knowledge transfer using teacher-student training has been widely applied in various domains of vision, including U.S. patent application Ser. No. 17/938,042, commonly assigned. In the present invention, teacher-student learning is used to train ‘student’ lightweight models from a pre-trained “still image” baseline detector as the teacher model. This approach has not been used in the past in the context of training efficient models for tracking object detections.

In an embodiment, the videos of interest use the H.264 or similar video encoding format (e.g., H.265 or HEVC, etc.) which captures key underlying compression algorithms of most modern video encoders. Frames in a video VD are encoded as series of interleaved I-frames, P-frames and B-frames. An I-frame (intra-coded) is a compressed image which is independent of the rest of the frames in the video; that is, it does not need information from either previous or later frames to display the entire image. The compression in an I-frame exploits spatial redundancy in the pixels to encode blocks of an image in the frequency domain (DCT), similar to JPEG level compressions. P-frames (predictive) and Bframes (bi-predictive) are motion compensated, differential frames from the nearby P/B or I frame. A group of P/B-frames between consecutive I-frames is termed as GOP (Group Of Pictures) whose size is denoted by NG. Bi-directional predictive B-frames use backward motion compensation in addition to forward motion compensation modeled by the P-frame. B-frames can be handled in the same way as P-frames in reverse temporal direction. Given the foregoing, for purposes of clarity and avoiding unnecessary duplication, further discussion of B-frames is omitted but their use is still within the scope of the present invention and reference to steps involving P-frames is to be understood as describing steps for B-frames as well as P-frames.

With discussion of P-frames understood as instructive of B-frames, a video received from a decoder can be considered as series of I frames spaced temporally apart from one another and groups of P frames intermediate to the I frames, such that video VD={I₀, P₀⁰, P₀¹, . . . , I₁, P₁⁰, P₁¹, . . . }, seen in FIG. 1A at 105A-C and 110A-B, respectively. The I-frames are processed through the baseline detector 115 to yield I frame detections 145. For simplicity, the superscript from the P-frame is sometimes dropped hereinafter as it always refers to the previous I-frame. A P-frame P₀ is composed of a motion vector frame M₀, and an entropy-encoded residual frame R₀, where the accumulated motion vectors and residuals of a GOP of P frames is indicated at 120, with the accumulated motion vectors indicated at 120A and the accumulated residuals indicated at 120B Typical H.264 videos have variable GOP sizes depending on the video content and degree of motion captured by P-frames between a pair of I-frames. In an embodiment of the present invention, for videos created with a moving camera, average GOP size NG≈145 while for stationary cameras it can go as high as NG≈250 or higher, as GOP size is typically determined by frame-to-frame change and there is no theoretical upper limit.

In an embodiment, motion vectors are extracted for each frame as a 2D matrix of motion vectors for variable sized macroblocks. In an embodiment, for each macroblock the invention maintains the source frame (i.e., the previous I/P-frame), the center of a macroblock in both the source and destination frame, as well as the width and height of the macroblock. In some embodiments, the framework of the present invention is optimized where NG is small, for example less than 30, in order to train lightweight models Shift, a lightweight neural network indicated at 130, and Refine or Refinement, a lightweight neural network indicated at 135, that are efficient for learning using teacher-student knowledge transfer. Smaller values of NG minimize the impact of motion errors, although in other implementations much larger values of NG will be acceptable, for example where frame-to-frame change is small. The Shift network receives as its input localized motion vectors 140 as well as I-frame detections 145 and provides shifted detections Bₛ, shown at 150. The Refine or Refinement network receives localized patch decoding, indicated at 155, where the localized patch decoding has as its inputs the accumulated residuals of the P-frames 110A-B as well as the motion vectors 120A and the shift detections 150. The refinement network outputs P-Frames detections 160. Even with small GOP size, potential processing gains for high resolution videos due to parallelization are considerable because the lightweight Shift and Refine networks process much faster than the baseline network. In some embodiments, supporting larger GOP sizes may necessitate more complex models which may result in diminishing returns in terms of performance.

The process flow described in FIG. 1A can be further appreciated from FIG. 1B, where, in an embodiment, a baseline detector 115 is first run on the I-frames 105 to yield detections 145. As described above, the I-frames are the fully reconstructed image at sparse temporal locations; i.e., between each I-frame in a video sequence there will typically be a quantity of P-frames and B-frames. A Shift network 130 propagates these detections to the intermediate P-frames, and runs on the motion vector images 120A which are readily available from the compressed video. The Shift network uses the well known ROIAlign algorithm to calculate the shift in x position, y position and scale of each bounding box returned by the baseline detector. (In some embodiments, the ROIWarp algorithm can be used, but potentially with lesser results.) Note that the term “Fixed sized features” refers to the fact that inputs to the Shift network are resized to a fixed patch size although they come from variable sized bounding boxes from the motion vector image. Using the P-frames 110A-B and the P-frame residuals 120B (which are also readily available from the compressed video), the original frame is reconstructed only around the shifted bounding boxes returned by the Shift network. A different network, called the Refine network takes variable sized cropped patches 155 from the reconstructed image around the shifted bounding boxes, resizes them to a fixed size and predicts the new detections in the P-frame, shown at 160.

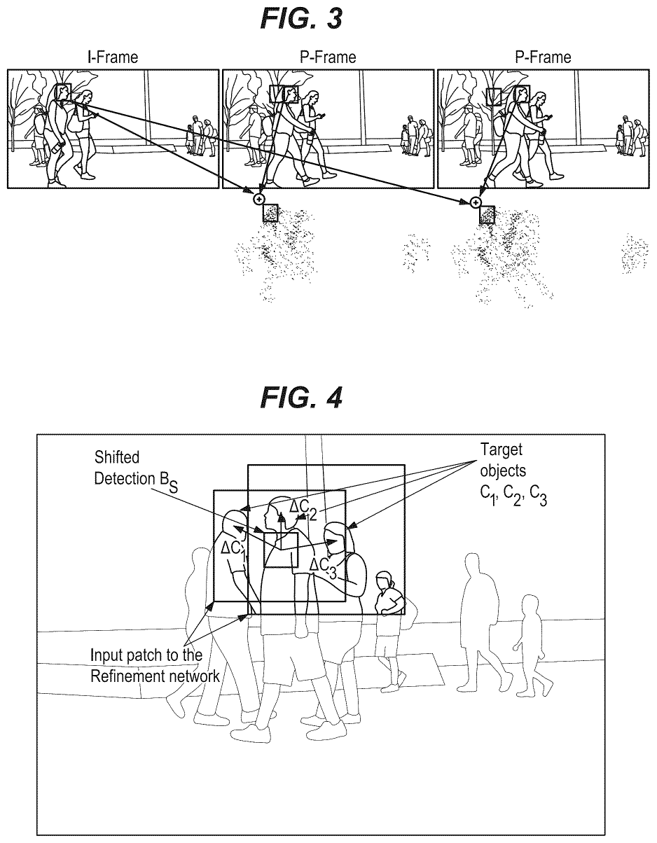

Temporal dependency between consecutive P-frames can be overcome by accumulating the changes for each consecutive P-frame and using only the last prior I-frame as the reference source frame. In an embodiment, this involves a fast pass across NG P-frames to accumulate the motion vectors and the residuals. For each P-frame, the accumulation code of the present invention maintains a two-channel motion vector image denoting how far the corresponding pixel-coordinate in the I-frame has shifted along the x and y axes. Accumulated shift at each pixel co-ordinate is computed by summing up the x/y motion vectors of all the macroblocks covering that coordinate. Macroblocks are not guaranteed to be discrete in the source frame. This means that the accumulation algorithm discussed above can copy an I-frame coordinate to multiple destination locations which results in more than one macroblock trying to increment the accumulated shift for an I-frame coordinate. This typically happens for less than 5% of the total pixels, and can be safely ignored when using multiple threads for accumulation. In the framework of the invention synchronization is omitted which allows for the possibility of a data race in these pixels. FIG. 3 illustrates the accumulation process, in which motion vector accumulation happens by passing an empty buffer for each macroblock from an I-frame across consecutive P-frames, and adding motion vectors for every pair of source and destination frames.

The Shift network is by design a motion prediction function [symbol] to model correlations between complex, accumulated motion vector patterns in the P-frames and the target object motion. This lightweight model predicts the shift from the accumulated motion vectors of the P-frame. It takes as an input the list of Rol (region of interest) from the current frame, for each bounding box detected in the referenced I-frame. The motion vector patterns in the Rol capture not only the motion trajectory of the target but also background context for inferring camera egomotion. For each bounding box B=[cx, cy, w, h], in an embodiment the Shift network uses the RolAlign operation to sample a fixed-size patch of motion vectors within the region specified by the Rol and predicts a three dimensional vector ΔB=[Δcx, Δcy, Δs] as the shift vector along the x and y axes, and the scale s. As the motion vectors in the P-frames are defined over macroblocks of pixels 8×8, the resolution of the motion vector image is much lower than that of the input frame. An embodiment of the invention take advantage of this by pooling the pixels into 8×8 buckets during the accumulation pass. This vastly cuts down on the computational cost while having minimal effect on detection accuracy. Target translation in an image is a composite of target motion and camera motion, which is only approximately captured by motion vector patterns in the P-frame. FIG. 2 illustrates the imprecision in the motion vector frames when compared to the optical flows, as computed using, for example, FastFlowNet.

Shift network learning using Knowledge Transfer: [symbol] is learned as a lightweight, two-layer shallow network using knowledge transfer in a teacher student learning framework. Specifically, supervisory labels from the baseline detector are used to train the Shift network. The detector acts as the teacher network to provide tracking labels for the student Shift network to predict offsets for a given input Rol of motion vectors. In at least some embodiments, the more complex the Shift network is, the more difficult it is to train, resulting in poor accuracy. This may be due to the inherent ambiguity in motion vectors for compressed video, leading to a higher risk of overfitting during training. The motion vectors are globally normalized for the entire frame. This allows for better discrimination between motion patterns due to target motion and background camera motion. In an embodiment, training the Shift network involves knowing the ΔB_{P} of the detection bounding box B_{P} in the current P-frame, relative to the corresponding bounding box B_{I} in the source I-frame. Relative offsets of the bounding box centers and scale in the corresponding I/P-frames are modeled as:

$$Δ cx = ( {cx}_{P} - {cx}_{I} ) / {I}_{w} , Δ cy = ( {cy}_{P} - {xy}_{1} ) / {I}_{h}$$

$$Δ s - log ( \frac{\sqrt{{w}_{P} {h}_{P}}}{\sqrt{{w}_{I} {h}_{I}}} ) where I - frame size = ( {I}_{w} , {I}_{h} )$$

In order to use supervisory labels from the teacher network, it is important in some embodiments to find the correct corresponding bounding box B_{P} in the current P-frame. This is realized by independently tracking each of the bounding boxes to the current decoded P-frame. For tracking, the standard single object Tracking algorithm can be used based on a pretrained Siamese-RPN framework. The Hungarian algorithm can then be used with IoU (Intersection over Union) as the metric to match the bounding boxes. For an I-frame bounding box B_{I} that is tracked to B_{I,P} and matches B_{P} in the current P-frame, the matching score M(B_{I},B_{P}) can be defined as:

$$\frac{( {𝒫}_{D} ( {B}_{P} ) + {𝒫}_{T} ( {B}_{I} , {B}_{I , P} ) + ( α {P}_{IoU} ( {B}_{I , P} , {B}_{P} ) )}{( 2. + α )}$$

where [symbol] denotes teacher network detection confidence, [symbol] is the accumulated tracking confidence normalized to 1.0, and [symbol] is the box overlapping score with α<1.0.

In at least some embodiments, a higher weight is given to detection and tracking scores compared to the degree of overlap when assessing validity of a label. This is to filter out cases where the observed target may be getting occluded or tracking is lost such as by the target moving out of the frame. Also, more importantly in some instances, motion vector cues are imprecise and cannot be expected to track bounding boxes with high overlapping ratio. The matching score M(B_{I},B_{P}) is used as a soft label for training [symbol] as a student network. For each pair of boxes that share the same tracklet ID such that the first box is in the I-frame and the second is in the P-frame, ΔB_{P}=B_{P}−B_{I} is used as the target label and loss is modeled as M(B_{I},B_{P})smooth_{LI}(ΔB, ΔB_{P}).

The Refinement network 135 can be further understood from the following. Coarse motion cues from the P-frames provide approximate localization of the target using the Shift network. Targets may get occluded or move out of the scene. The Refinement network utilizes accumulated residual frames to further refine these shifted bounding boxes. It either generates precise localization of the targets, or detects their disappearance. It is assumed that the appearance of targets will be detected during I-frame processing. New appearances can also be handled by applying backward processing from the next 1-frame using the foregoing techniques. Fully reconstructed localized patches with enlarged context are used as inputs to the Refinement model, because the highly discontinuous image differences in residuals can pose a challenge for extracting meaningful cues in the inference process.

For a shifted bounding box B_{S} obtained from the Shift network, in an embodiment reconstructed image patches [symbol] and (B_{S};W) are used as inputs to the Refinement model. Here W is the rescaling parameter for bounding box B_{S} to include context around it for refinement. Patch reconstruction happens on the GPU, and the Refinement model uses RolAlign to extract variable sized patches from accumulated residuals, motion vectors and the reference I-frame. The reconstructed patches are resized to fixed-size inputs and processed using the Refinement network.

In an embodiment, the confidence scores of the original detections predicted by the baseline detector network [FIGS. 1A-1B] are used as informative features in the Refinement model 135. These scores are concatenated with the patch feature in the input. At least some embodiments of the Refinement model have both classification and regression heads. The classification head attempts to infer possible loss of observation due to occlusion or target moving out of the scene. The regression head predicts the refined bounding box relative to the shifted bounding box B_{S} which is at the center of the reconstructed patch.

The Refinement network 135 is also trained using teacher-student knowledge transfer, whereby the baseline detection model provides supervisory labels for training the student refinement model. Classification and regression target labels for the refinement network are generated from the associated bounding boxes B_{P} from the teacher model in the current P-frame. A pre-condition to do so is to first associate teacher labels to the shifted detections B_{S} of the referenced I-frame. A custom bounding box overlapping metric is used that emphasizes how much a shifted bounding box covers the pseudo-labels from the teacher network. This metric intentionally downweighs the need for B_{S} to have similar size as Bₚ, but favors large B_{S} with larger context for refinement:

$${𝒪}_{P} = \frac{{B}_{S} ∩ {B}_{P}}{area ( {B}_{P} ) )}$$

Note that B_{S} could be large and enclose multiple labels. In those cases the closest labels are preferred as discussed later in this section. Associations with Oₚ<0.25 are treated as negative examples. Multiple shifted detections could get associated to a single Bₚ, in which case each pair is used as a training data point.

The classification head is trained to detect the shifted prediction is occluded or has disappeared. The teacher detection score [symbol] is used to create soft labels for the knowledge transfer. The classification loss function for the positive examples is:

$${ℒ}_{conf} ( {B}_{S} , {B}_{P} ) = − {𝒫}_{D} \cdot log ( \frac{exp ( {c}^{1} )}{exp ( {c}^{1} ) + exp ( {c}^{0} )} )$$

where [c⁰, c¹] is the output from the classification head. For negative examples, there is no reweighing term with cross entropy loss. Negative training labels are generated by randomly sampling boxes of variable sizes around a valid target or as hard negatives during the training process.

The regression head is trained to output offsets relative to a shift at the center of the patch [symbol] (B_{S};W) with the pseudo labels as ΔB_{P}=B_{P}−B_{S}. The regression loss is defined only for positive samples and is reweighted similar to cross-entropy loss

$${ℒ}_{loc} ( {B}_{R} , {B}_{P} ) = {𝒫}_{D} ⋆ {smooth}_{L 1} ( {B}_{P} , {B}_{R} )$$

where ΔB is the offset relative to Bₛ as outputted from the Refinement model. An appropriately rescaled image patch from [symbol] (B_{S};W) is important to disambiguate cases when the patch contains multiple possible targets. In those cases a prior term is added to favor bounding boxes closer to the center of the patch:

$${ℒ}_{center} ( {B}_{R} ) = β * {‖ ( Δ c x , Δ cy ) ‖}_{2}$$

As an example, in an embodiment β is given a low weight of 0.05 and W=1.5 for training purposes. In addition to the shifted predictions from the Shift network Bₛ, random locations are sampled around Bₚ, and are used to train the Refinement model. This is part of the data augmentation process, although in at least some embodiments the training can happen in parallel and independent of the Shift network training by only using random samples as the targets for refinement. Detections from the teacher network with scores greater than 0.01 are used as soft labels in at least some embodiments.

With reference to FIG. 4, an example of using center prior to resolve ambiguity can be appreciated. Center prior is used to train models that favor refined boxes that are close to the center of the input patch. In FIG. 4, the presence of multiple target objects (faces) in the input patch creates ambiguity, which is resolved by the center prior approach as favoring target two, where amongst the three possible targets, the prior favors target two as ΔC₂<ΔC₁<ΔC₃.

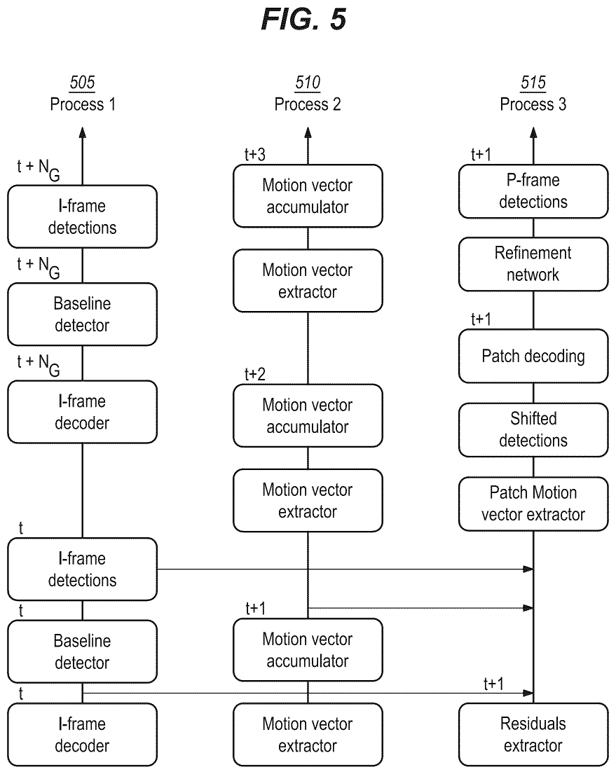

The Inference Pipeline of the present invention is a highly parallelized system for incrementally propagating localized changes relative to the detections from the baseline detector. Video decoding is a critical bottleneck in the inference pipeline, and is therefore run as a separate process. Processing P-frames has a referential dependency on the preceding I-frames, each of which can be processed using separate processes. FIG. 5 shows the multiprocess flow diagram of the inference engine. Process 1, indicated at 505, runs the accumulation of motion vectors and residuals on the P-frames, while Process 2, indicated at 510, runs the baseline detector on the I-frames. Processes 1 and 2 have non-blocking dependencies on other processes. Process 3, indicated at 515, runs the Shift and Refinement networks on the P-frames, and has a blocking dependency on both Process 1 and Process 2. Frames in the GOP are processed in parallel in Process 3, and therefore speed gains can be improved with higher GOP sizes. The tradeoff between speed gains and deteriorating accuracy due to the need for learning more complex motion patterns in the P-frames determines the optimal GOP size used in the framework of an embodiment of the invention. More complex Shift and Refinement networks incur additional processing costs. In some embodiments of the processing pipeline Process 3 always gets throttled by Process 2 due to the high computational requirement of the baseline detector. In at least some embodiments, the complexity of the Shift and Refinement models can be increased until there is no blocking.

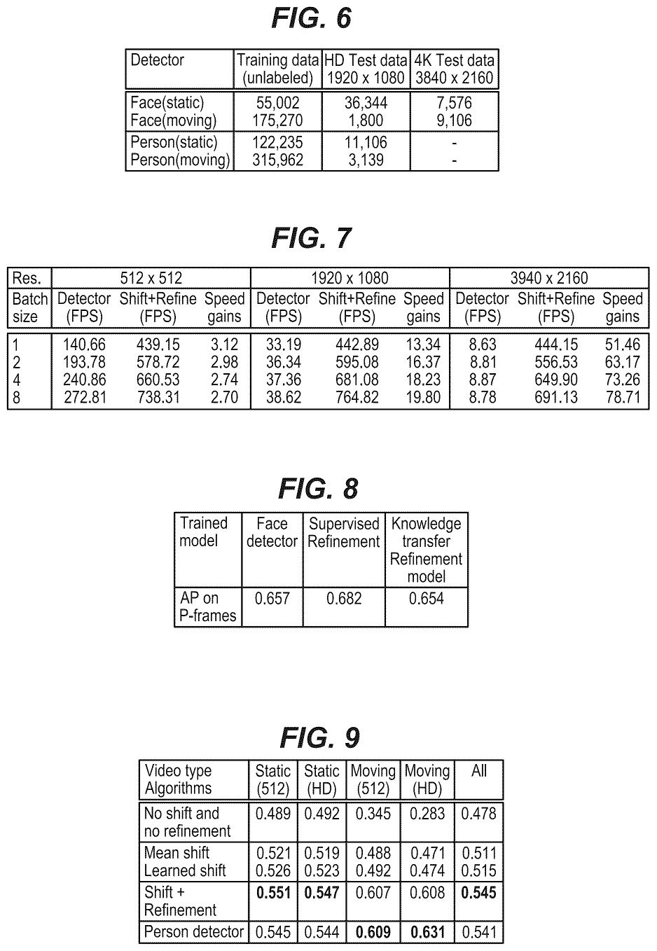

The framework of the present invention is designed to be agnostic to the detectors and object class(es) it can detect in at least some embodiments, and to significantly boost its speed, especially on high resolution video, by exploiting attributes of compressed data. Tests were run on two classes of object—person and face. Shown in FIGS. 6-10 are the results of tests designed to measure the speed, accuracy, and ability of the Shift/Refine framework to boost the speed of a generic baseline detector. Since the framework treats the baseline detector as a black box and does not need any of its internal details, it is justified to assess the relative (rather than absolute) speed and accuracy and training complexity, over the baseline detector.

For testing the framework of the invention, the baseline detector was a standard SSD (Single Shot Detection) object detector on top of darknet 53-layers (persons) and resnet 50-layers (face) as foundational feature extractors. Although not critical for testing purposes, the choice of SSD as the teacher network is driven by the fact that it achieves a good balance between speed with accuracy, and therefore has enjoyed widespread adoption as the preferred detector for many practical applications. GOP size NG was fixed at 10 in experiments conducted in accordance with the invention. Note that this does not limit the framework's practical applicability, as the original video does not need to be encoded with this GOP size. Rather, when processing a video with a large GOP size, a source I-frame is reconstructed after the NG P-frames, and the motion vector accumulation is run relative to it. As discussed previously, a GOP size of 10 achieves a good compromise between the complexity required for the shift and refine networks and speed gains achievable with the framework of the present invention.

The Shift network is trained as a two-layer network with 256 channels. Inputs to the Shift network are variable-sized bounding boxes, resized to a fixed patch size. The patch is normalized to preserve the magnitude and orientation of the motion vectors, and its size is determined from the mean aspect ratio of the object. For faces the size of 24×16 was used while for persons a size of 44×16 was used. The Refinement network is a single feature map with Mobilenet0.25 as the backbone feature extractor. Inputs to the Refinement network are the fixed-size cropped patches of the decoded P-frame. Note that decoding of the localized patches happens in the GPU using RoIALign to extract regions from the source I-frame, the motion vector and the residual components of the P-frame. This is significantly faster than decoding the entire P-frame. Patches are all resized to 64×64 and processed in batches of 128 for training. The top-most layer emits a feature map 1×1 feature map of depth 256. The Refinement model training used extensive data augmentation to overcome variations due JPG artifacts, color changes, lighting and brightness changes. In addition, small translation perturbations were added in the input patches for robustness to noisy predictions from the Shift network.

Training of both the networks is performed using SGD and independently. Learning rate is set to 0.001, learning rate decay is 0.001, and weight decay to 0.0005. The models were trained for 100 epochs. A small validation set was used to determine optimal values for these parameters, after which they were fixed. Also, detection confidences were used as soft pseudo-labels for knowledge transfer. Models trained on hard labels underperformed and so were dropped from evaluation. For motion vector and residuals extraction, an embodiment of the invention used ffmpeg.

The baseline detectors used for testing are fully convolutional (Single Shot Detector) and have been trained at varying resolutions. In the tests the detectors were used to process high resolution imagery with input resolution ranging from 512×512 to 1024×1024. For persons, the MOT 2017 dataset was used to provide a rich set of HD 1920×1080 videos with labeled persons for evaluation. For faces, the WILDTRACK dataset was used including multiple HD resolution videos with labeled faces. For UltraHD videos, various Youtube videos were labeled. A summary of total frames and videos used in an exemplary embodiment of a framework in accordance with the invention is listed in the table of FIG. 6. Tests were run using both stationary and moving cameras.

The table of FIG. 7 shows the speed gains achieved using the framework of the present invention for different video resolutions. In these tests, the same detector was used to process the videos of different resolutions. Notice that the gain factors are dramatically higher for higher resolution videos, thus demonstrating the framework as a powerful enabling technology for processing high resolution videos.

Detector accuracy is measured as area under the precision-recall curve or average precision (AP). Several tests were conducted to assess effects of various components in the inference pipeline. In some embodiments of the invention, knowledge transfer learning is critical for training the models. In order to assess the accuracy of the training framework, experiments were first conducted to compare accuracy of the face detector (only on P-frames) on static cameras, when the refinement model is trained using teacher-student framework, with when it is trained using supervised labels. The table of FIG. 8 shows the AP obtained for the models along with the original face detector accuracy. While supervision helps the pipeline to perform better, the accuracy of the refinement model via knowledge transfer is comparable to the baseline. Note that temporal motion cues could cause shift and refinement to outperform the original detector's accuracy. This is not unusual for static cameras where tracking is more accurate than frame-by-frame object detection.

The table of FIG. 9 shows the accuracy of inference pipeline when the I-frames are processed at 512 resolution and 1024 resolution (HD). Videos with stationary cameras and moving cameras are compared separately. The first row shows accuracy when no shift and refinement processing is performed. The bounding boxes stay in the same location as detected in the I-frames.

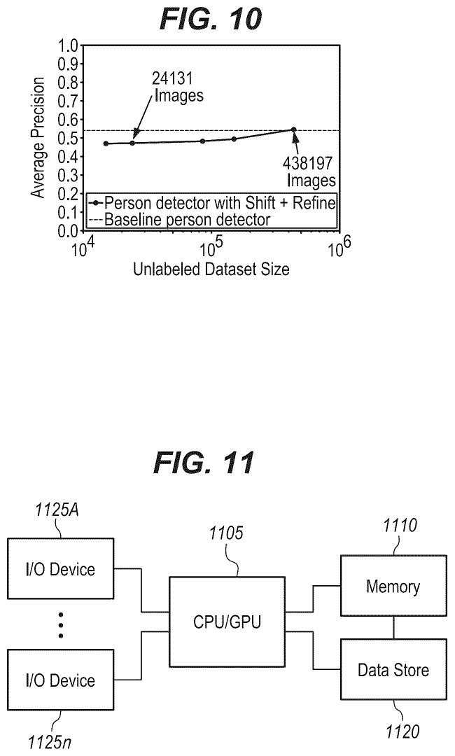

The plot of FIG. 10 illustrates a key result and contribution of a framework in accordance with an embodiment of the invention. End-to-end tests were conducted for training Shift and Refinement models for the person/object detector with increasing amounts of unlabeled data. As the plot shows there is a clear trend of improving accuracy when more unlabeled data is used in the teacher-student training framework. From this it can be inferred that, given more and more unlabeled data, the accuracy will keep improving up to some undetermined plateau.

FIG. 11 illustrates a computer system suitable for executing code written to perform the processes and methods described herein. A processor 1105 such as a CPU or GPU communicates bidirectionally with memory 1110 and data store 1120 and also with I/O devices 1125A-1125n.

The foregoing teachings disclose a novel framework to greatly increase processing speeds of object detectors for high resolution videos using an approach of shifting and refining detections obtained from sparse processing of the video frames. The framework employs motion cues encoded in compressed data, and locally decoded patches. Further speed gains are achieved by forgoing the need to decode the entire frame and with highly parallelized processing of intermediate predictive P-frames using lightweight Shift and Refinement networks. The framework has widespread applicability due to lack of the need for labeled data. Training can use unlabeled, representative videos, and employs teacher-student based knowledge transfer learning to seamlessly train the models. Finally, the framework works with any generic object detection model.

Those skilled in the art will appreciate that, among other aspects, the present invention comprises a method for performing detections on high resolution compressed video streams at native resolution where the compression protocol uses sparse key frames and motion vectors for the intermediate frames comprising the steps of receiving a compressed video sequence comprising a plurality of key frames and a plurality of intermediate frames where the key frames are temporally spaced apart with a plurality of intermediate frames positioned temporally between the key frames, running a plurality of key frames at native resolution against a baseline neural network detector to generate a plurality of object detections, a bounding box associated with at least some object detections, accessing, from the compressed video, a plurality of motion vectors representative of associated intermediate frames at native resolution, accessing, from the compressed video, a plurality of intermediate frame residuals representative of associated intermediate frames at native resolution, accumulating the plurality of motion vectors, accumulating the plurality of frame residuals, running the accumulated motion vectors against a shift lightweight neural network to calculate shift in X position, Y position and scale of each of the bounding boxes and providing the results of the calculation as shift detections, and running the shift detections together with at least the accumulated frame residuals against a refine lightweight neural network to determine object detections in the intermediate frames.

Those skilled in the art will further recognize that the invention includes a method wherein the baseline neural network detector is a teacher network and the shift and refine lightweight neural network are student networks. Still further, it will be appreciated that in some embodiments the key frames are I frames and the intermediate frames are P frames and B frames, wherein the accumulated motion vectors and frame residuals of the P frames are run against a first pair of the shift lightweight neural network and the refine lightweight neural network and the B frames are run against a second pair of the shift lightweight neural network and refine lightweight neural network. It will also be appreciated that, in at least some embodiments, training of the shift and refine lightweight neural networks is performed using the outputs of the baseline detector without the use of additional labeled data. Still further, in some embodiments the shift network uses an RolAlign operation to sample a fixed-size patch of motion vectors within a specified region of interest and predicts a three dimensional vector ΔB=[Δcx, Δcy, Δs] as the shift vector along the x and y axes, and the scale s.

It will also be appreciated from the foregoing that, in at least some embodiments, only a portion of a frame is decompressed while still achieving the desired improvement in speed and, in some cases, accuracy. It is to be understood that, in some embodiments, the shift network uses coarse motion cues to provide approximate localization of one or more objects' bounding boxes and the refine network utilizes accumulated residual frames together with the approximate localization either to generate precise localization of the one or more objects or to detect their disappearance.

Another aspect of the invention comprises a system for performing detections on high resolution compressed video streams at native resolution where the compression protocol uses sparse key frames and motion vectors for the intermediate frames comprising receiving, in a computer, a compressed video sequence comprising a plurality of key frames and a plurality of intermediate frames where the key frames are temporally spaced apart with a plurality of intermediate frames positioned temporally between the key frames, in the computer, running a plurality of key frames at native resolution against a baseline neural network detector to generate a plurality of object detections, a bounding box associated with at least some object detections, accessing, from the compressed video, a plurality of motion vectors representative of associated intermediate frames at native resolution, accessing, from the compressed video, a plurality of intermediate frame residuals representative of associated intermediate frames at native resolution, accumulating the plurality of motion vectors, accumulating the plurality of frame residuals, in the computer, running the accumulated motion vectors against a shift lightweight neural network to calculate shift in X position, Y position and scale of each of the bounding boxes and providing the results of the calculation as shift detections, and in the computer, running the shift detections together with at least the accumulated frame residuals against a refine lightweight neural network to determine object detections in the intermediate frames.

Systems in accordance with the invention can be configured to have the baseline neural network detector be a teacher network and the first and second lightweight neural network be student networks. Further, in some systems according to the invention, the key frames are I frames and the intermediate frames are P and B frames, wherein the accumulated motion vectors and frame residuals of the P frames are run against a first pair of the shift lightweight neural network and the refine lightweight neural network and the B frames are run against a second pair of the shift lightweight neural network and refine lightweight neural network. In some systems training of the shift and refine lightweight neural networks is performed using the outputs of the baseline detector without the use of additional labeled data. Further, in some embodiments of a system in accordance with the invention, the refine network is used to overcome a lack of rich motion information in the compressed video while the shift network ensures that decoding of a frame patch is needed only in a localized region.

Stated more generally, the present invention should be understood to comprise methods and systems for performing detections at native resolution in high resolution video streams without requiring reconstruction of each frame comprises a baseline detector for performing object detections on key frames such as I frames in H.264 or H.265 video together with a shift lightweight neural network for calculating, from accumulated motion vectors of intermediate frames such as B frames and P frames, shift in the object detections and also together with a refine lightweight neural network responsive to the calculations from the shift network and accumulated frame residuals of the intermediate frames to determine object detections in the intermediate frames.

In some embodiments described herein, plural instances may implement components, operations, or structures described as a single instance and vice versa. Likewise, individual operations of one or more embodiments may be illustrated and described collectively, one or more of the individual operations may be performed concurrently, and the operations may be performed in an order different than that illustrated. Structures and functionality presented as separate components in example configurations may be implemented as a combined structure or single component. Similarly, structures and functionalities presented as separate components may be implemented as a single component. These and other variations, modifications, additions, and improvements fall within the scope of the subject matter herein.

Embodiments described herein as including components, modules, or mechanisms may comprise either software modules (e.g., code embodied on a machine-readable medium or in a transmission signal) or hardware modules. A hardware module comprises a tangible unit configured or arranged to perform the requisite operations. In example embodiments, one or more computer systems (e.g., a standalone, client or server computer system, co-located or remote from one another) or one or more hardware modules of a computer system (e.g., a processor or a group of processors) may be configured either by software (e.g., an application or application portion) or as a hardware module that operates to perform certain operations as described herein.

In various embodiments, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within one or more general-purpose processors or other programmable processors) that is temporarily configured by software to perform certain operations. It will be appreciated that the implementation of a hardware module in a particular configuration may be driven by cost and time considerations.

Embodiments in which one or more hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).) The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are to be understood merely as convenient labels associated with appropriate physical quantities.

Unless specifically stated otherwise, terms such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The phrase “in an embodiment” used in various places in the specification do not necessarily all refer to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Having fully described a preferred embodiment of the invention and various alternatives, those skilled in the art will recognize, given the teachings herein, that numerous further alternatives and equivalents exist which do not depart from the invention. Thus, while particular embodiments and implementations have been illustrated and described, it is to be understood that the invention is not limited to the precise embodiments, structures and configurations disclosed herein but is to be limited only by the appended claims.

1. A method for performing detections on high resolution compressed video streams at native resolution where the compression protocol uses sparse key frames and motion vectors for the intermediate frames comprising the steps of
receiving a compressed video sequence comprising a plurality of key frames and a plurality of intermediate frames where the key frames are temporally spaced apart with a plurality of intermediate frames positioned temporally between the key frames
running a plurality of key frames at native resolution against a baseline neural network detector to generate a plurality of object detections, a bounding box associated with at least some object detections,
accessing, from the compressed video, a plurality of motion vectors representative of associated intermediate frames at native resolution,
accessing, from the compressed video, a plurality of intermediate frame residuals representative of associated intermediate frames at native resolution,
accumulating the plurality of motion vectors
accumulating the plurality of frame residuals,
running the accumulated motion vectors against a shift lightweight neural network to calculate shift in X position, Y position and scale of each of the bounding boxes and providing the results of the calculation as shift detections, and
running the shift detections together with at least the accumulated frame residuals against a refine lightweight neural network to determine object detections in the intermediate frames.

2. The method of claim 1 wherein the baseline neural network detector is a teacher network and the shift and refine lightweight neural network are student networks.

3. The method of claim 1 wherein the key frames are I frames and the intermediate frames are P frames and B frames, wherein the accumulated motion vectors and frames residuals of the P frames are run against a first pair of the shift lightweight neural network and the refine lightweight neural network and the B frames are run against a second pair of the shift lightweight neural network and refine lightweight neural network.

4. The method of claim 2 wherein training of the shift and refine lightweight neural networks is performed using the outputs of the baseline detector without the use of additional labeled data.

5. The method of claim 1 wherein the shift network uses an RolAlign operation to sample a fixed-size patch of motion vectors within a specified region of interest and predicts a three-dimensional vector ΔB=[Δcx, Δcy, Δs] as the shift vector along the x and y axes, and the scale s.

6. The method of claim 1 wherein only a portion of a frame is decompressed.

7. The method of claim 1 wherein the shift network uses coarse motion cues to provide approximate localization of one or more objects' bounding boxes and the refine network utilizes accumulated residual frames together with the approximate localization either to generate precise localization of the one or more objects or to detect their disappearance.

8. A system for performing detections on high resolution compressed video streams at native resolution where the compression protocol uses sparse key frames and motion vectors for the intermediate frames comprising the steps of
receiving, in a computer, a compressed video sequence comprising a plurality of key frames and a plurality of intermediate frames where the key frames are temporally spaced apart with a plurality of intermediate frames positioned temporally between the key frames,
in the computer, running a plurality of key frames at native resolution against a baseline neural network detector to generate a plurality of object detections, a bounding box associated with at least some object detections,
accessing, from the compressed video, a plurality of motion vectors representative of associated intermediate frames at native resolution,
accessing, from the compressed video, a plurality of intermediate frame residuals representative of associated intermediate frames at native resolution,
accumulating the plurality of motion vectors,
accumulating the plurality of frame residuals,
in the computer, running the accumulated motion vectors against a shift lightweight neural network to calculate shift in X position, Y position and scale of each of the bounding boxes and providing the results of the calculation as shift detections, and
in the computer, running the shift detections together with at least the accumulated frame residuals against a refine lightweight neural network to determine object detections in the intermediate frames.

9. The system of claim 8 wherein the baseline neural network detector is a teacher network and the first and second lightweight neural network are student networks.

10. The system of claim 8 wherein the key frames are I frames and the intermediate frames are P frames and B frames, wherein the accumulated motion vectors and frames residuals of the P frames are run against a first pair of the shift lightweight neural network and the refine lightweight neural network and the B frames are run against a second pair of the shift lightweight neural network and refine lightweight neural network.

11. The system of claim 8 wherein training of the shift and refine lightweight neural networks is performed using the outputs of the baseline detector without the use of additional labeled data.

12. The system of claim 8 wherein the refine network is used to overcome a lack of rich motion information in the compressed video while the shift network ensures that decoding of a frame patch is needed only in a localized region.

13. The system of claim 8 wherein only a portion of a frame is decompressed.

14. A non-transitory computer readable storage medium comprising stored instructions for performing detections on high resolution compressed video streams at native resolution where the compression protocol uses sparse key frames and motion vectors for the intermediate frames, the instructions when executed causing at least one processor and data storage in communication therewith to:
receive a compressed video sequence comprising a plurality of key frames and a plurality of intermediate frames where the key frames are temporally spaced apart with a plurality of intermediate frames positioned temporally between the key frames
run a plurality of key frames at native resolution against a baseline neural network detector to generate a plurality of object detections, a bounding box associated with at least some object detections,
access, from the compressed video, a plurality of motion vectors representative of associated intermediate frames at native resolution,
access, from the compressed video, a plurality of intermediate frame residuals representative of associated intermediate frames at native resolution,
accumulate the plurality of motion vectors
accumulate the plurality of frame residuals,
run the accumulated motion vectors against a shift lightweight neural network to calculate shift in X position, Y position and scale of each of the bounding boxes and providing the results of the calculation as shift detections, and
run the shift detections together with at least the accumulated frame residuals against a refine lightweight neural network to determine object detections in the intermediate frames.

15. The non-transitory computer readable storage medium of claim 14 wherein the baseline neural network detector is a teacher network and the shift and refine lightweight neural network are student networks.

16. The non-transitory computer readable storage medium of claim 14 wherein the key frames are I frames and the intermediate frames are P frames and B frames, wherein the accumulated motion vectors and frames residuals of the P frames are run against a first pair of the shift lightweight neural network and the refine lightweight neural network and the B frames are run against a second pair of the shift lightweight neural network and refine lightweight neural network.

17. The non-transitory computer readable storage medium of claim 15 wherein training of the shift and refine lightweight neural networks is performed using the outputs of the baseline detector without the use of additional labeled data.

18. The non-transitory computer readable storage medium of claim 14 wherein the shift network uses an RolAlign operation to sample a fixed-size patch of motion vectors within a specified region of interest and predicts a three-dimensional vector ΔB=[Δcx, Δcy, Δs] as the shift vector along the x and y axes, and the scale s.

19. The non-transitory computer readable storage medium of claim 14 wherein only a portion of a frame is decompressed.

20. The non-transitory computer readable storage medium of claim 14 wherein the shift network uses coarse motion cues to provide approximate localization of one or more objects' bounding boxes and the refine network utilizes accumulated residual frames together with the approximate localization either to generate precise localization of the one or more objects or to detect their disappearance.
